(19) United States
(12) Patent Application Publication
(10) Pub. No.: US 2009/0282618 A1
(43) Pub. Date: Nov. 19, 2009

(54) Scrapbooker's Impact Tool

(76) Inventor: David O. Meyers, Kaysville, UT (US)

Correspondence Address: LEGENDS LAW GROUP, PLLC, 503 WEST 2600 SOUTH, SUITE 200, BOUNTIFUL, UT, 84010, US

(21) Appl. No.: 12/417,590

(22) Filed: Apr. 2, 2009

Related U.S. Application Data
(60) Provisional application No. 61/072,892, filed on Apr. 2, 2008.

(51) Int. Cl. B25D 1/00

(52) U.S. Cl. 7/144

(57) ABSTRACT

A scrapbooker's impact tool is provided. The tool is configured to store energy in a controlled manner until it is released by the user. The released energy is useful for punching and riveting operations.

### FIELD OF THE INVENTION

The present invention relates to a scrapbooking tool for mechanically delivering an impact to a surface from simple applied pressure.

### BACKGROUND OF THE INVENTION

Scrapbooking is a popular activity. Persons involved in scrapbooking (“scrapbookers”) often desire to punch holes in paper, and/or punch out shapes in paper and other materials. Also, they often want to create punched shapes from, and/or install eyelets, grommets, and the like, in paper and various additional materials. Such additional materials can include—but are not limited to—cardstock, cloth, and polymeric resin films—to name some examples. Heretofore this has been done using an appropriate punch or riveting tool, and using a hammer to provide the impact typically required using such a tool. As will be readily appreciated, a mis-strike using a hammer and punch (or riveting tool or the like) can damage an artistic workpiece. Where appearance of the work is extremely important—as it nearly always is in scrapbooking—this is problematic. Using a hammer and punch can be particularly difficult for some scrapbookers, for example inexperienced scrapbookers and persons with nerve/muscle impairment or other physiological symptoms affecting fine motor control, steadiness, or otherwise making using a hammer and punch difficult.

### SUMMARY OF THE INVENTION

The inventor's contribution to the art is a scrapbooker's impact tool adapted specifically for scrapbooking, which delivers an impact from simple applied pressure. In one example, this allows practitioners to place the tool and apply pressure slowly, and in a more controllable manner, storing energy in the device until it is released to drive a tool operation in scrapbooking. The energy is released at a point in time when sufficient energy is available, as the scrapbooker continues to push down on the tool. As an example, the tool is placed as desired, and pressure applied until the accumulated energy is released in a single blow delivered within the device to tooling held against the workpiece. It will be appreciated that the need for a hammer is obviated, and punching and riveting operations in scrapbooking are simplified.

In an example of this a tool it has an energy storage element, a trigger element and a restoring/resetting element. In one example the first and last of said three elements can be springs of some type; and the trigger element is actuated to release the stored energy in the energy storage element at a desired time when sufficient energy is available to provide an impact, and the restoring (or resetting) element then restores the tool to a neutral state ready for the next impact operation. This can be repeated.

The tool in one example is able to receive tooling pieces for various operations, such as punches for punching holes or making cut-out shapes, embossing heads for making embossed shapes in paper, film, or other deformable sheet material, riveting tooling pieces for eyelets, grommets, rivets, etc. of various sizes, to name some examples.

In one example the tool can include a base which receives the tool for convenient storage. The base can have storage bins or compartments for additional tooling pieces, for eyelets of various sizes, or for other supplies for scrapbooking operations using the impact tool.

The above-described features and advantages of the present invention, as well as additional features and advantages, will be set forth or will become more fully apparent in the description that follows. Furthermore, the features and advantages of the invention may be learned by the practice of the invention, or will be obvious to one skilled in the art after referring to the invention description, as set forth hereinafter.

### BRIEF DESCRIPTION OF THE DRAWINGS

Various embodiments of the present invention are shown and described in reference to the numbered drawing wherein:

FIG. 1 is a schematical cross-sectional view of an example scrapbooker's impact tool in accordance with principles of the invention in a neutral reset position prior to use to impart an impact blow;

FIG. 2 is a schematical cross-sectional view of the example of FIG. 1 wherein pressure has been applied and energy stored in an energy storage element (a spring 16 in the example), and the device is just about to impart a blow, a trigger element (24) moving against friction toward alignment with a hole in a hammer element (14), which alignment will release the stored energy and drive the hammer element towards a tool piece (32) held in a tool receiver to impart an impact thereto;

FIG. 3 is a schematical cross-sectional view of the example of FIG. 2, wherein stored energy has just previously been released and the hammer element is driven toward the workpiece and impacted with the trigger element, which transmits it through a tipping ball (26) and tooling receiver (20) and tooling piece to the workpiece, in this example an eyelet (42) which is shown deformed under the blow;

FIG. 4 is a side view of the tool example of FIG. 1 resting in a base (60) configured to provide tool storage and provided with a central well to receive the impact tool of this example;

FIG. 5 is a top view of the example of FIG. 4, storage bins being shown in hidden line as they are under a rotating top cover except for a single open bin; and

FIG. 6 is a cross-sectional view, taken along line 6-6 in FIG. 5 of the example of FIG. 5 showing the internal arrangements of the base as well as the impact tool resting in the well of said base.

It will be appreciated that the drawings are illustrative and not limiting of the scope of the invention which is defined by the appended claims. Further, like reference numbers refer to like (but not necessarily identical) elements throughout the figures and the example(s) and variations thereof illustrated in the figures. The embodiments shown accomplish various aspects and objects of the invention.

### DETAILED DESCRIPTION OF THE INVENTION

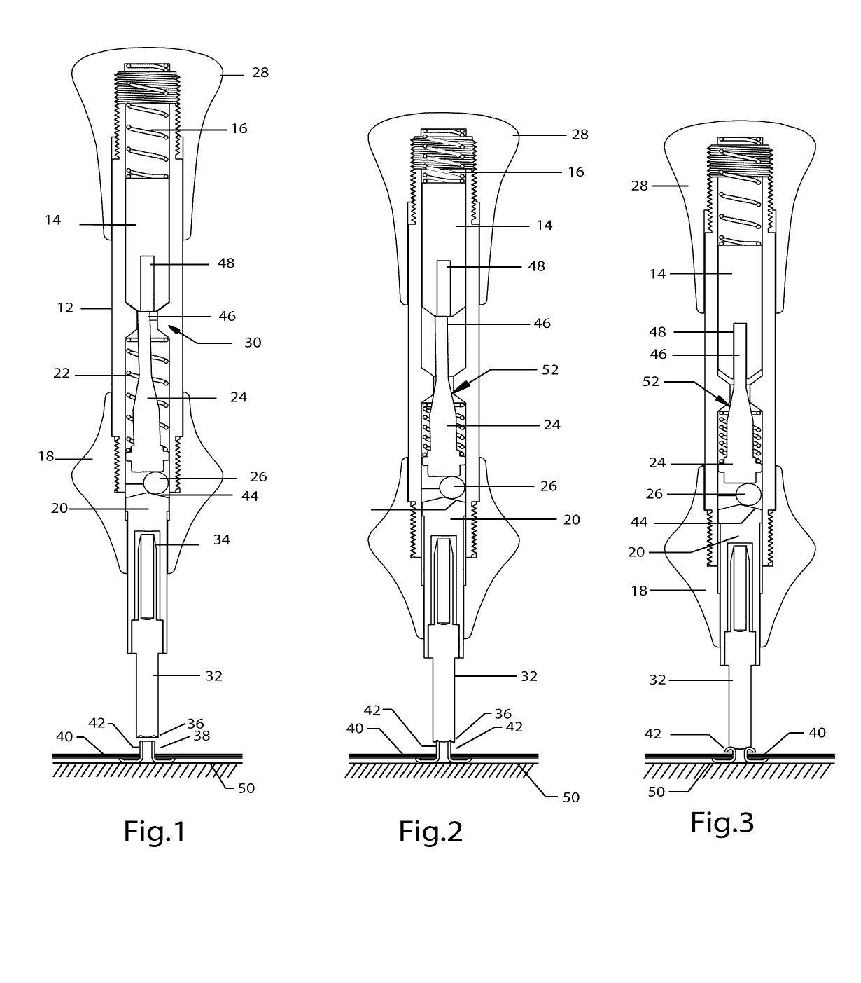

With reference to FIG. 1, at the time of filing a preferred embodiment of the invention in an impact tool 10 includes an outer sleeve 12 which slidably holds a hammer 14 and an energy storage element, in this example a heavy spring 16 which stores impact energy, as will be further described below. In the illustrated embodiment a grip portion 18 attached to the sleeve cooperates with the sleeve to slidably hold a tool receiver element 20 and a restoring, or resetting, element, in this example is a light return spring 22. The grip portion also provides a stop for a users hand to push against in applying pressure to the device, and thus increases a user's ability to apply force and ability to obtain purchase on the tool during use. The tool allows a scrapbooker to apply a steady force until an impact blow is administered and then resets to allow force to again be applied until enough energy is available in the energy storage device, whereupon another blow is struck.

The particulars of how this is done in the example include the fact that the sleeve 12 also contains a trigger element 24 and a tipping ball 26. A flared end cap 28 closes the upper end of the sleeve, and contains the hammer and heavy spring within the sleeve. These elements thus contained are positioned above a guide portion 30 of the sleeve located intermediate its ends. The end cap also provides for better purchase, and can be configured in a bulbous shape for more comfortable griping and manual application of force. This element compliments and cooperates with the grip portion 18 to provide a ready grasp and good purchase on the tool by a user in order to apply force. The grip portion extends the hollow interior of the sleeve 12 (downward in the figures) and cooperates with the sleeve to contain the tool receiver 20, tipping ball 26, trigger element 24, and return spring 22 in the interior of the sleeve (as extended by the grip portion) below the guide portion 30 of the sleeve. Both the flared end cap 28 and the grip portion are threaded onto the sleeve in the illustrated embodiment. It will be appreciated that the arrangement facilitates simple assembly of the illustrated example device during its manufacture, The parts are placed in the sleeve in order and the end cap and grip portion are threaded onto the sleeve over them to hold them in place in the interior of the sleeve.

The tool receiver 20 is adapted to hold tooling for scrapbooking tasks requiring impact, and can hold a multiplicity of different tooling types, e.g. tooling for punching round holes, tooling for punching cut-out shapes of various kinds (e.g. stars, hearts, and the like), or tooling for riveting or embossing operations. An example combination tool piece 32 used in riveting is fitted in the tool receiver in the illustrated embodiment. In one example the receiver can be magnetized to hold the tool piece; and in another example variation, can include a detent arrangement (conventional, not shown) configured to hold a tooling piece—such as the combination tool piece illustrated—in the tool receiver. The combination tool piece illustrated is reversible, and includes a hole punch 34 at one end and an eyelet riveting punch 36 at the other end. This tool piece is adapted to make a hole 38 in a workpiece sheet 40; then be removed, rotated, replaced in the tool receiver and deform (or “rivet’) an eyelet 42 to fix and retain it within the hole previously made in one example.

The process of creating an impact for riveting in fixing the eyelet 42 in the sheet material 40 of the workpiece in this example is illustrated in FIGS. 1, 2, and 3. As the impact tool 10 is brought into contact with the workpiece eyelet, and before any pressure is applied, the return spring 22 exerts a small force on the trigger element 24. This urges it against the tipping ball 26. The tipping ball rests against a slightly conical or rounded upper end 44 of the tool receiver. The conical shape forces the ball outward against the inside wall of the sleeve 12, where it rests off-center. Another shape of the tool receiver and/or trigger element that urges the ball to an off-center position can be used. The reaction, in turn, tips the trigger element so that it is tipped out of axial alignment with the sleeve; and an upper end 46 of the trigger element rests against the sleeve in the more narrow guide portion 30. The upper end of the trigger element is thus biased into a position where it is essentially prevented from aligning with and entering a hole 48 in the lower end of the hammer element 14 when the tool 10 is in an initial (reset) state and the elements are in a “neutral” position. The return spring pushes the receiver and the other elements out (downward in the figures) to an initial (or neutral) position, checked by the grip portion 18 from coming out of the device. This is the reset function of the return spring: it moves all the elements to the neutral (or initial) position shown in FIG. 1 when no force is being exerted on the tool by a user, The tool is thus ready for a next impact operation.

The eyelet riveting portion 36 of the combination tool piece 32 is placed against the eyelet 42, which rests on a hard impact-resistant surface 50. As will be appreciated with reference particularly to FIG. 2, as pressure is firmly and continuously applied to the impact tool 10 (in a downward direction in the figures), the heavy spring 16 is compressed as the sleeve 12 advances downward, storing energy for the impact to come. The return spring is also compressed, but less energy and force are involved. As the heavy spring is compressed, the guide portion 30 of the sleeve 12 begins to straighten the axial alignment of the trigger element 24 with that of the sleeve as the sleeve continues to advance (downward in the figure), now further compressing the return spring on one side and easing off the return spring on the other side as the trigger element is righted and aligned by movement of the guide portion of the sleeve against a tapered portion 52 of the trigger element. This interaction of the sleeve and trigger element overcomes the tipping influence of the return spring and tipping ball 26 and the friction between the trigger element and the hammer 14. If pressure continues to be applied, the trigger element slides into alignment with the hole 48 defined by and located within a lower portion of the hammer. This releases the hammer from the restraint of the trigger element, and the heavy spring can then release its stored energy, accelerating the hammer forcefully downward. The stored energy in the heavy spring 16 is converted into kinetic energy of the relatively heavy hammer element thus impelled to moving rapidly downward.

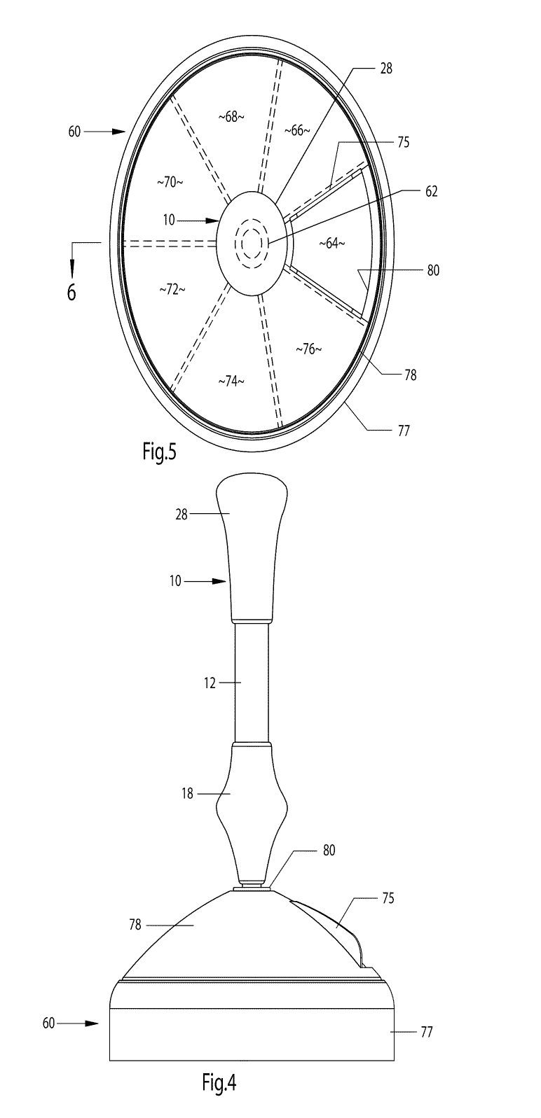

As shown in FIG. 3, the downward movement of the hammer 14 is checked when the upper portion 46 of the trigger element 24 bottoms in the hole 48 in the bottom of the hammer element. A sharp and forceful blow is thus delivered to the combination tool piece 32 and thus to the workpiece (the eyelet 42 in the illustrated example) from the hammer via the tool receiver 20, tipping ball 26, and trigger element, and indeed to some extent by the sleeve 12 and the rest of the device 10 which by their mass and associated resistance to sudden acceleration in a direction opposite to the movement of the hammer directs more of the kinetic energy into the tool piece and thus to the workpiece. This is further illustrated in FIG. 3 in that the eyelet can be seen deforming under the blow delivered to it.

Depending on the operation being performed, a single blow or multiple blows can be delivered, as the device is self-resetting. The user simply again applies pressure while the tool piece 32 rests on the workpiece 42. As will be appreciated, between blows, when pressure on the device, e.g. via the end cap 28 and sleeve-extension grip portion 18, is removed by the practitioner (not shown) the device resets to the initial or neutral position state, as the return spring 22 pulls the trigger element 24 down out of the hole 48 in the bottom of the hammer 14. The tipping ball 26 then cooperates with the return spring to tip the trigger element askew, to again rest against the inside of the sleeve in the narrow guide portion 30 as shown in FIG. 1. The return spring pushes all the elements out again to the previously mentioned neutral position, ready for the next impact-use cycle which is a repeat of that just described. The device is thereby reset, and ready to be again compressed to repeat the process to deliver another blow.

It will be appreciated that the particulars of how the energy is stored and the blow delivered in the illustrated example is one of a number of ways in which this can be accomplished. The illustrated example is simple, and can be made at relatively low cost, but other schemes for storing and releasing energy to provide an impact could replace that shown and described herein as an exemplary embodiment. For example air springs or non-coiled mechanical springs can be used instead of the coil springs of the illustrated example.

With reference to FIGS. 4, 5 and 6, in one example embodiment the impact tool 10 can be storable in a complementary base 60. The base can have a central well 6224 configured to receive the impact tool 10, and a number of bins 64, 66, 68, 70, 72, 74, 76 in a round base tray 77 which carries a rotatable cover 78. The bins can hold supplies, e.g. rivets, eyelets, grommets, etc., and extra tool pieces, e.g. various punch, rivet, embossing, etc, tools and combination tool pieces for various tasks, The rotating cover closes all but one bin at any one time. Thus, in the unlikely event the base is upset, the contents of the bins will not be mixed, and only that of one may spill out. Upwardly extending tabs 75 facilitate rotation of the cover. In one embodiment a snap-tight cover 79 can be provided which interfits with the tabs to releasably snap tight in place over them and a bin access opening 81 therebetween and prevent such a spill when covering over this single bin access opening in the rotating cover 78.

The well 62 in this example is formed by a snap-tight insertable well piece 80. When this well piece is inserted through a central opening in the cover 78 and into the tray 77 sufficiently far, it detentably seats in place and prevents the cover 78 from coming off the tray. But it still allows the cover to rotate around the well piece over the tray. This arrangement makes assembly of the base unit simple, as the cover is simply placed over the tray, and the well piece is then inserted trough the cover into the tray to lock the three elements 77, 78, 80 in place with respect to each other. It will be appreciated that the base unit can be formed of a polymeric resin by an injection molding process. Moreover, in another embodiment instead of a snap-tight fit, the well-piece could be solvent-, heat- or ultrasonically welded into the tray to hold the cover when plastics are thus used. Other materials, such as wood, metals, composites, etc. can be substituted for polymeric resin as to any or all of said three elements, with appropriate means for attachment of the well piece to the tray being used in each case.

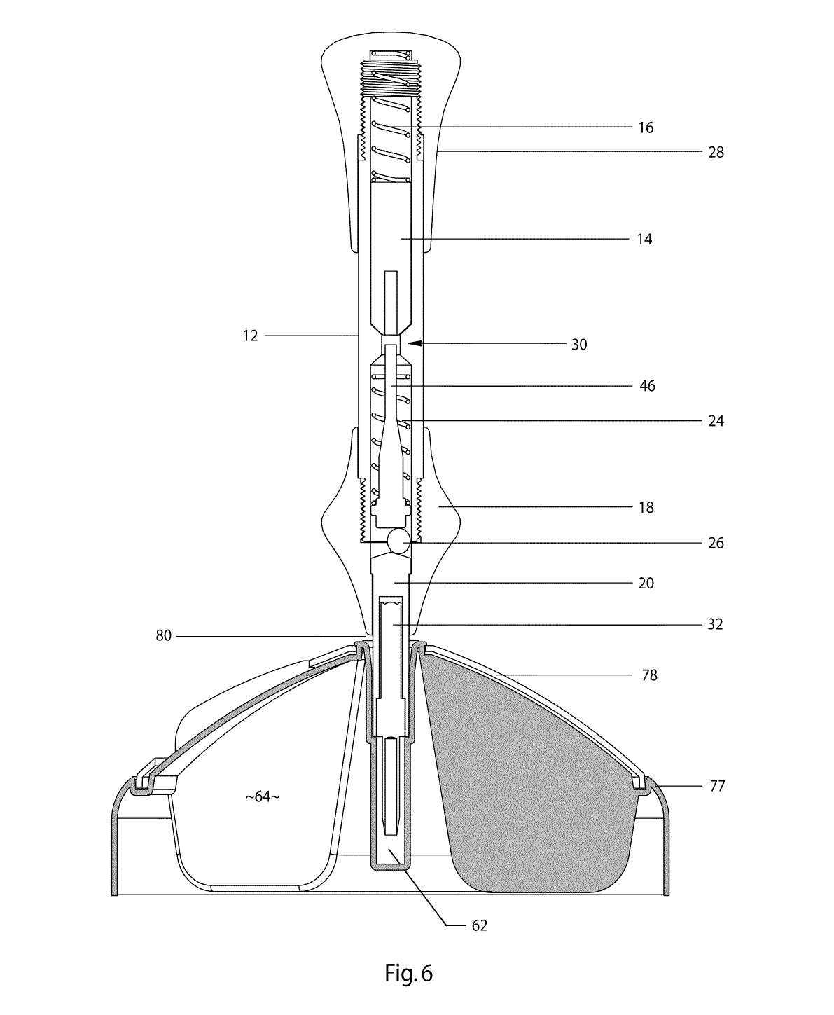

With reference particularly to FIG. 6, the sleeve 12 of the impact tool can be formed of a metal, such as aluminum or steel, or can be formed of a filled polymeric resin. In the latter case the composite material is selected to be impact resistant, as it must contain the tipping ball 26 as impact is transmitted through the tipping ball. The sleeve san be machined or molded, or made by a combination thereof. The hammer 14 and tipping trigger element 24 are formed of metal(s) of a relatively high density and elastic modulus, and can be hardened where they contact each other and other elements such as the tipping ball 26 to reduce ductility. The tipping ball and tool receiver 20 are also formed of appropriate metals and can be selectively hardened. The importance of the management of ductility will be appreciated with respect to the fact that repeated impacts over a long service life are contemplated. An appropriate steel alloy material is used in one embodiment to form each of these elements. These elements can be hardened at least at the places they contact other elements, or appropriate metals are chosen for the elements in combination so that the material(s) will not deform as they are pushed together under repeated blows. This is because impact is transmitted primarily through these elements, and—again—they must resist deformation from repeated blows over a long service life.

The sleeve extending grip portion 18 can be formed of aluminum, or a filled polymeric resin of high strength and impact resistance. It can be formed of the same material as the sleeve in one example. However, since it takes less stress and impact than the sleeve it can be made of a different material. Likewise the end cap 28 can be formed of polymeric resin, aluminum, a filled polymeric resin, or another sufficient$ strong material. Both the grip portion and the end cap can itself be formed of a material that is not only sufficiently strong, but can be configured with outer surfaces providing good frictional engagement with a user's hands (not shown) or which can be coated with a high-friction material to facilitate better purchase. This will be further discussed below. The end cap can be made of an elastically deformable material to increase comfort (as well as purchase) and can be likewise adapted in materials and/or coatings to provide better grip for the scrapbooker.

As just mentioned, the surfaces of the end cap 28 and sleeve extending grip portion 18 can be treated so as to provide good grip, and—combined with their shape—good purchase. In this connection they may be dimpled, or coated with a high friction material, for example, as mentioned so that the user is confident of the grip and stability of the impact tool 10 in hand during use. Likewise, the exterior of the sleeve 12 can be treated by surface configuration and/or coating(s) to provide good grip, thus further increasing the likelihood that users will be able to obtain and maintain a good hold during use.

Generally speaking, the shapes of the end cap 28 and grip portion 18 cooperate with the sleeve and any surface treatment to provide good purchase for the user. The use of elastically deformable materials in selective locations can also increase purchase, in addition to providing increased comfort in use, especially repeated use by a scrapbooker where comfort and good purchase can reduce user fatigue.

It will be appreciated that these principles can be implemented in other embodiments not shown by way of example herein. It will be appreciated that the impact tool 10 in accordance with principles of the invention will simplify scrapbooking operations requiring one or more impacts. Since the tool allows careful relative placement before applying pressure, the operations can be more easily accomplished, especially by novice and physically challenged scrapbookers. Moreover, the base unit provides convenient storage not only of the impact tool 10, but of tooling and supplies for its use. The invention thus provides improvements in the art of scrapbooking and can reduce waste due to errors in punching and riveting of scrapbooking materials, as well as reduce fatigue on the part of the user. It can increase the user's confidence that the outcome will be aesthetically pleasing and that less errors will occur during punching and riveting operations and the like.

While the invention has been illustrated and described herein with respect to specific example(s), it will be appreciated that numerous modifications can be made without exercise of inventive faculty. It is not intended that the invention be limited, except by the claims, which follow.

1. A scrapbooker's impact tool, comprising:
a tool configured for use in scrapbooking activities requiring an impact, the tool configured to receive tooling for a plurality of said activities, and further comprising
an energy storage element;
a trigger element;
a resetting element;
cooperating to allow a constant firm pressure on the tool to be converted into a sharp impact blow after sufficient energy is stored, and afterward enabling the tool to be reset for subsequent use.

2. A Scrapbooker's impact tool as set forth in claim 1, wherein the tooling includes at least one of a punch tool and a riveting tool.

3. A scrapbooker's impact tool as set forth in claim 2, wherein the tooling comprises a combination tool enabling punching and riveting.

4. A scrapbooker's impact tool as set forth in claim 1, wherein the energy storage element comprises a coil spring.

5. A scrapbooker's impact tool as set forth in claim 1, further comprising a grip configured to provide improved purchase.

6. A scrapbooker's impact tool as set forth in claim 5, further comprising a surface treatment configured to provided improved purchase.

7. A scrapbooker's impact tool as set forth in claim 1, wherein the trigger element is configured to facilitate release of the energy stored in the energy storage element by a movement of the trigger element when sufficient energy is stored in the energy storing element.

8. A scrapbooker's impact tool as set forth in claim 1 further comprising a base wherein the tool can be inserted for storage.

9. A scrapbooker's impact tool as set forth in claim 8, wherein the base further comprises storage, thus enabling storage of at least one of (a) additional tooling and (b) scrapbooking supplies for activities wherein the impact tool is usable.

10. A scrapbooker's impact tool as set forth in claim 9, further comprising at least one cover cooperating with the base to facilitate containment of said additional tooling and additional scrapbooking supplies in the base.

11. A scrapbooker's impact tool as set forth in claim 10, wherein the base includes a plurality of storage bins, and one movable cover allows selective access to each of the bins.

12. A scrapbooker's impact tool, comprising:
a tool for performing scrapbooking tasks requiring impact, including a receiver for tooling, and further comprising an energy storage element and a trigger element and a restoring element; the tool being configured to hold the received tooling against a scrapbooking work piece, and to release stored energy to provide an impact, and to reset for a further impact.

13. A scrapbooker's impact tool as set forth in claim 12, wherein the energy storage element comprises a spring and the restoring element comprises a spring.

14. A scrapbooker's impact tool as set forth in claim 13, further comprising a grip portion configured to provide increased purchase.

15. A scrapbooker's impact tool as set forth in claim 13, further comprising tooling that can be received in the receiver in a plurality of positions, each position corresponding with a task to be performed by the tool in scrapbooking.

16. A scrapbooker's impact tool as set forth in claim 13, further comprising a base having a well configured to receive the impact tool for convenient storage.

17. A scrapbooker's impact tool as set forth in claim 16, wherein the base further comprises a plurality of separate storage bins for examples of at least one of tooling and scrapbooking supplies.

18. A scrapbooker's impact tool comprising
a tool receiver configured to receive scrapbooking tooling for performing scrapbooking tasks involving impact;
an energy storage element configured to store impact energy;
a trigger element configured to release impact energy
a resetting element configured to restore the tool to a condition for again storing energy for a further impact, and
a base configured to hold the impact tool.

19. A scrapbooker's impact tool as set forth in claim 18, further comprising tooling enabling performing a plurality of tasks requiring impact in scrapbooking activities.

20. A scrapbooker's impact tool as set forth in claim 19, wherein the base comprises a plurality of bins configured for holding at least one of tooling and scrapbooking supplies.
